(19) United States
(12) Patent Application Publication
(10) Pub. No.: US 2009/0141319 A1
(43) Pub. Date: Jun. 4, 2009

(54) IMAGE FORMING DEVICE, IMAGE FORMING METHOD AND COMPUTER READABLE MEDIUM

(75) Inventors: Takehito Utsunomiya, Kawasaki-shi (JP); Hideki Hirose, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/275,549

(22) Filed: Nov. 21, 2008

(30) Foreign Application Priority Data
Nov. 29, 2007 (JP) 2007-308996

(51) Int. Cl. H04N 1/46

(52) U.S. Cl. 358/505

(57) ABSTRACT

The present invention relates to an image forming device that realizes accurate image forming positioning at a desired position without any complex operation about the image forming position by firmware in the image forming device that can involve the unevenness or mounting position difference of lenses of a deflection scanning device. The image forming device obtains the amount of shift in a subscanning direction of image forming from the image forming position of the image data in the main scanning direction and from the curve correction information, adds dummy data by the number of lines of shifting the reading position of the image data at the image forming start position in accordance with the amount of shift obtained, and delivers the dummy data added and the image data to an image forming component.

### BACKGROUND OF THE INVENTION

1. Field of the Invention

The present invention relates to an image forming device, and particularly to a color image forming device which has a developing unit for a plurality of colors, and has a function of successively transferring a plurality of color images formed by an individual developing unit.

2. Description of Related Art

Conventionally, electrophotography is known as an image recording method used for a color image forming device such as a color printer and color copying machine. The electrophotography forms a latent image on a photoconductive drum using a laser beam, and carries out development using charged color materials (referred to as “toners” from now on). The recording of the image is performed by transferring and fixing a developed toner image to transfer paper.

Recently, to improve image forming speed of an electrophotographic color image forming device, the number of tandem color image forming devices has been increasing, each of which has developers and photoconductive drums as many as the colors of toners, and transfers different color images successively onto an image conveyor belt or a recording medium. As for the tandem color image forming devices, several factors causing misregistration have been known, and a variety of methods of handling them have been proposed for each factor.

One of the factors is the unevenness or mounting position difference of lenses of a deflection scanning device, and the fixing position difference of a deflection scanning device to the body of the color image forming device. The position difference causes a slope or curve in the scanning line, and the degree of the curve (referred to as “profile” from now on) which can differ for each color results in the misregistration.

The profile has different characteristics in each image forming device, that is, in each recording engine and in each color. Examples of the profile are shown in FIG. 13A to FIG. 13D. In FIG. 13A to FIG. 13D, horizontal axes indicate positions in the main scanning direction in the image forming device. Straight lines 1301, 1303, 1305 and 1307 in the main scanning direction indicate ideal characteristics without any curve. In contrast, line 1302, line 1304, line 1306 and line 1308 denoted by curved lines indicate profiles of respective colors. Thus, the line 1302 indicates the characteristics of cyan (called C from now on), the line 1304 indicates the characteristics of magenta (called M from now on), the line 1306 indicates the characteristics of yellow (called Y from now on), and the line 1308 indicates the characteristics of black (called K from now on). Vertical axes indicate the amount of difference in the subscanning direction with respect to the ideal characteristics. As shown in FIG. 13A to FIG. 13D, points of changes of the curved lines vary from color to color, and the variations appear as the misregistration in the image data after the fixing.

As a method of handling the misregistration, Japanese Patent Laid-Open No. 2002-116394 discloses a method of measuring the magnitude of the curve of each scanning line with an optical sensor in the assembling process of the deflection scanning device, and adjusting the curves of the scanning lines while rotating the lenses mechanically, followed by fixing them with an adhesive.

In Japanese Patent Laid-Open No. 2003-241131, the magnitude of the slope of each scanning line is measured with an optical sensor in the process of mounting a deflection scanning device on a color image forming device. Then, it describes a method of mounting the deflection scanning device on the color image forming device after adjusting the slope of each scanning line while mechanically tilting the deflection scanning device.

In addition, Japanese Patent Laid-Open No. 2004-170755 discloses a method of measuring the magnitude of slopes and curves of each scanning line with an optical sensor, correcting bitmap image data in such a manner as to cancel them out, and forming the corrected image. Since the method carries out the correction electrically by processing the image data, it obviates the need for a mechanical adjustment component or adjustment process at the assembling. Accordingly, it can miniaturize the color image forming device, and handle the misregistration at a lower cost than the methods disclosed in Japanese Patent Laid-Open No. 2002-116394 or 2003-241131.

The electrical misregistration correction is divided into one-pixel unit correction and less-than-one-pixel unit correction. The one-pixel unit correction offsets the pixels by one pixel in the subscanning direction in accordance with the amount of correction of the slopes and curves as shown in FIG. 14. Incidentally, in the following description, the position to be offset is referred to as “line changing process”. Thus, in FIG. 14, P1 to P5 correspond to the line changing processes.

The less-than-one-pixel unit correction adjusts the gray level of the bitmap image data as shown in FIG. 15A to FIG. 15E, using the upper and lower pixels in the subscanning direction (FIG. 15D). More specifically, when the scanning line inclines upward because of the profile characteristics shown FIG. 14, it handles the bitmap image data before the gray level correction in the direction opposite to the direction of the difference the profile indicates with respect to the subscanning. Performing the less-than-one-pixel unit correction by such a technique can eliminate unnatural differences in levels at a line changing process boundaries brought about by the one-pixel unit correction, thereby being able to smooth the image.

However, when the image forming device, which has the unevenness or mounting position difference of lenses of the deflection scanning device, carries out desired image forming, the following problem arises. More specifically, it can sometimes result in that an image is formed at a position different from the position in the subscanning direction determined in advance by the layout position of the image in the main scanning direction or from a position different from the position designated by a user. Accordingly, to always start printing of the image from the same position, it is necessary for the conventional correction method to make fine adjustment to the image forming start position (Top Margin) of the image data as required with firmware according to the width of the bitmap image data on a memory and the layout position in the main scanning direction.

### SUMMARY OF THE INVENTION

An object of the present invention is to implement image forming at a desired position without any complex calculation about the image forming position by firmware in the image forming device that may involve the unevenness or mounting position difference of lenses of the deflection scanning device.

An image forming device in accordance with the present invention includes an image data storage component, a reading component, an image forming component, a curve correction information storage component, and a correction component. The image data storage component is configured to store image data corresponding to at least one color component of an image. The reading component is configured to read out the image data on the basis of a designated reading position of the image data corresponding to each color component stored in the image data storage component. The image forming component is configured to form an image of each color component to paper according to the image data read out of the image data storage component by the reading component. The curve correction information storage component is configured to store curve correction information depending on accuracy of an exposure unit of the image forming component. The correction component is configured to correct the designated reading position of the image data of each color component in accordance with the curve correction information of each color component, the curve correction information of each color component being read out of the curve correction information storage component by the reading component in conjunction with the image data. The correction component further obtains the amount of shift in a subscanning direction of image forming from the image forming position of the image data in the main scanning direction and from the curve correction information, adds dummy data by the number of lines of shifting the designated reading position of the image data at the image forming start position in accordance with the amount of shift obtained, and transmits the dummy data added and the image data to the image forming component.

The image forming device can be configured as a tandem color image forming device.

An image forming method in accordance with the present invention is a method carried out in the image forming device including the image data storage component, the reading component, the image forming component; the curve correction information storage component and the correction component. The image forming method includes the steps of: obtaining the amount of shift in a subscanning direction of image forming from the image forming position of the image data in the main scanning direction and from the curve correction information; adding dummy data by the number of lines of shifting the designated reading position of the image data at the image forming start position in accordance with the amount of shift obtained; and transmitting the dummy data added and the image data to the image forming component.

According to the present invention, it is possible to implement image forming at a desired position without any complex calculation about the image forming position by firmware in the image forming device that may involve the unevenness or mounting position difference of lenses of the deflection scanning device.

Further features of the present invention will become apparent from the following description of exemplary embodiments (with reference to the attached drawings).

### BRIEF DESCRIPTION OF THE DRAWINGS

FIG. 1 is a cross-sectional view of an example (outline) of an electrophotographic color image forming device to which the present invention is applicable;

FIG. 2A is a diagram showing an example of profile characteristics of a scanning line of each color of the image forming device;

FIG. 2B is a diagram showing an example of profile characteristics of a scanning line of each color of the image forming device;

FIG. 3A is a diagram showing a profile and its direction to be corrected;

FIG. 3B is a diagram showing a profile and its direction to be corrected;

FIG. 3C is a diagram showing a profile and its direction to be corrected;

FIG. 3D is a diagram showing a profile and its direction to be corrected;

FIG. 4 is a diagram showing a configuration of individual blocks relating to electrostatic latent image formation in an electrophotographic color image forming device of an embodiment in accordance with the present invention;

FIG. 5A is a schematic diagram showing a state of data stored in a storage unit;

FIG. 5B is a diagram showing an upward shift of pixel data at a line changing process;

FIG. 5C is a diagram showing a downward shift of pixel data at a line changing process;

FIG. 6A is a diagram showing a distortion state of a laser scanner for a single color and its profile data;

FIG. 6B is a diagram showing the distortion state of the laser scanner for the single color and its profile data;

FIG. 6C is a diagram showing the distortion state of the laser scanner for the single color and its profile data;

FIG. 7A is a diagram showing an example of image data stored in a memory for forming an image on paper;

FIG. 7B is a timing diagram at a time of forming an image on paper according to the image data shown in FIG. 7A;

FIG. 8A is a diagram showing a distortion state of a laser scanner for a single color and its profile data;

FIG. 8B is a diagram showing the distortion state of the laser scanner for the single color and its profile data;

FIG. 9A is a diagram showing an example of image data stored in a memory for forming an image on paper;

FIG. 9B is a diagram showing image data at a time of transmitting image data to an image forming unit which has the unevenness or mounting position difference of lenses of a deflection scanning device;

FIG. 10 is a diagram showing that the position of the image data to be subjected to image forming differs from the original layout position;

FIG. 11 is a flowchart illustrating processing in the present embodiment;

FIG. 12 is a diagram showing a state in which the image data is laid out at a desired position by the present invention;

FIG. 13A is a diagram showing an example of the amount of shift of the laser scanning in the subscanning direction of a color;

FIG. 13B is a diagram showing an example of the amount of shift of the laser scanning in the subscanning direction of a color;

FIG. 13C is a diagram showing an example of the amount of shift of the laser scanning in the subscanning direction of a color;

FIG. 13D is a diagram showing an example of the amount of shift of the laser scanning in the subscanning direction of a color;

FIG. 14 is a diagram illustrating registration correction based on profile data;

FIG. 15A is a diagram illustrating less-than-one-pixel registration correction;

FIG. 15B is a diagram illustrating the less-than-one-pixel registration correction;

FIG. 15C is a diagram illustrating the less-than-one-pixel registration correction;

FIG. 15D is a diagram illustrating the less-than-one-pixel registration correction; and

FIG. 15E is a diagram illustrating the less-than-one-pixel registration correction.

### DESCRIPTION OF THE EMBODIMENTS

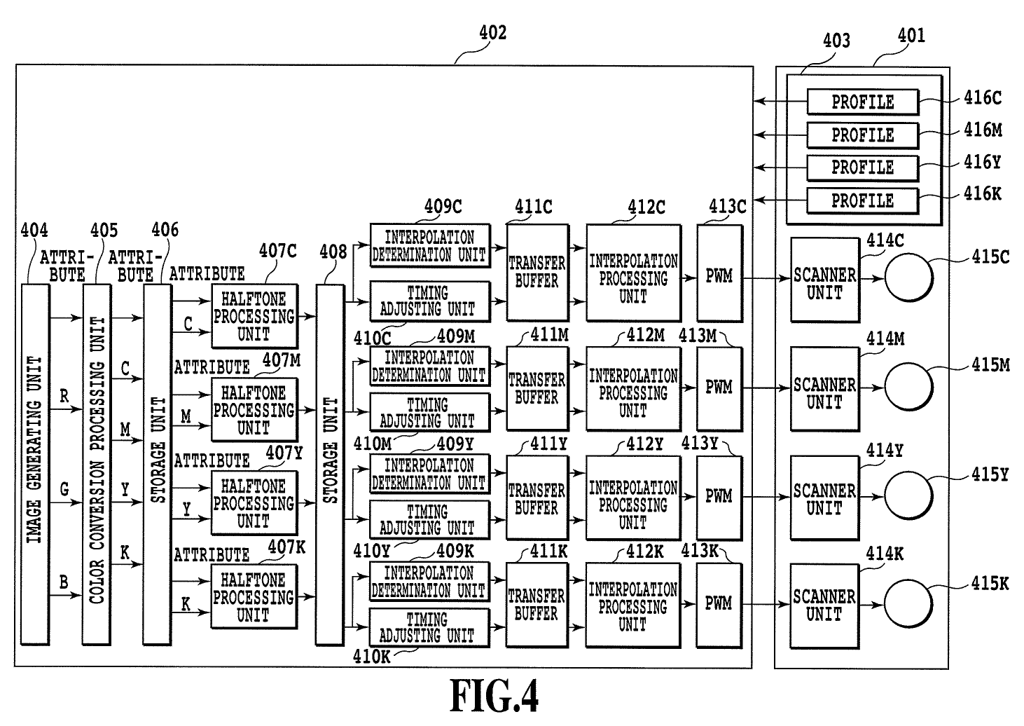

FIG. 4 is a diagram showing a configuration of individual blocks relating to electrostatic latent image formation in an electrophotographic color image forming device of an embodiment in accordance with the present invention. The color image forming device includes an image forming unit 401 and an image processing unit 402. The image processing unit 402 generates bitmap image information, and according to it, the image forming unit 401 performs image forming on a recording medium.

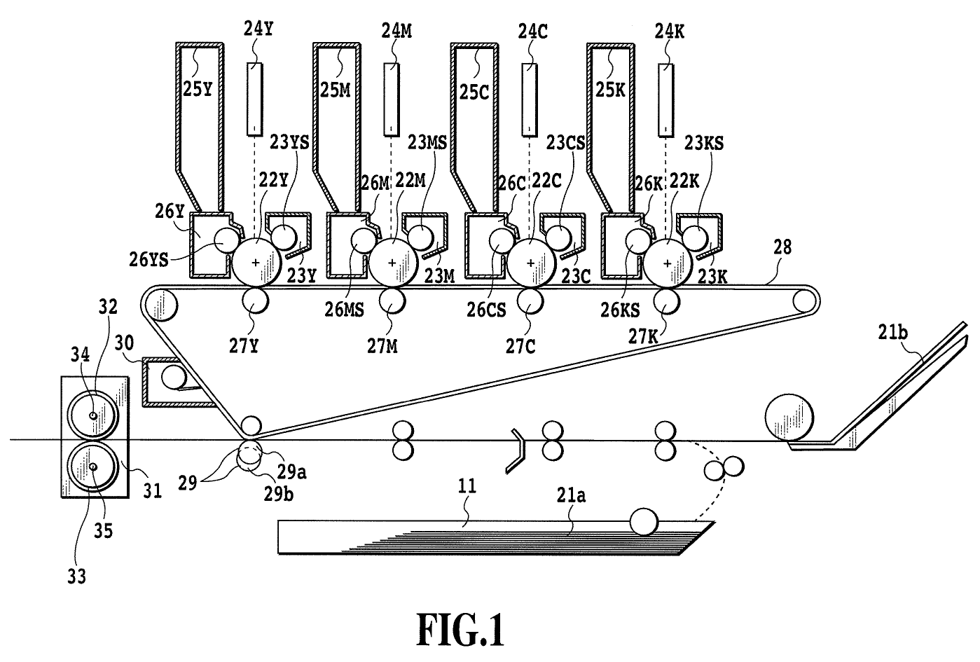

Here, referring to FIGS. 1 and 4, the operation of the image forming unit 401 in the electrophotographic color image forming device will be described. FIG. 1 is a cross-sectional view of a tandem color image forming device employing an intermediate belt 28, which is an example of the electrophotographic color image forming device.

Referring to FIG. 4, the image forming unit 401 forms electrostatic latent images by driving exposure light in accordance with the exposure time the image processing unit 402 takes for the processing, and forms monochromatic toner images for respective colors by developing the electrostatic latent images. The image forming unit 401 forms a multicolor toner image by superimposing the monochromatic toner images, transfers the multicolor toner image onto a recording medium 11, and fixes the multicolor toner image on the recording medium.

A charging unit includes four injecting chargers 23Y, 23M, 23C and 23K for electrifying photoconductive drums 22Y, 22M, 22C and 22K for respective colors Y, M, C and K, and the injecting chargers have sleeves 23YS, 23MS, 23CS and 23KS, respectively.

The photoconductive drums 22Y, 22M, 22C and 22K rotate by receiving driving force of a driving motor not shown. The driving motor rotates the photoconductive drums 22Y, 22M, 22C and 22K in a counterclockwise direction when viewed from the front of FIG. 1 in response to the image forming operation. An exposure unit is configured in such a manner as to form the electrostatic latent images by causing scanner units (exposure units) 24Y, 24M, 24C and 24K to illuminate the photoconductive drums 22Y, 22M, 22C and 22K with exposure light to selectively expose the surfaces of the photoconductive drums 22Y, 22M, 22C and 22K.

A developing unit includes four developing devices 26Y, 26M, 26C and 26K for developing to visualize the electrostatic latent images for respective colors Y, M, C and K, and the developing devices have sleeves 26YS, 26MS, 26CS and 26KS, respectively. The developing devices 26Y, 26M, 26C and 26K are detachable, and are loaded with ink tanks 25Y, 25M, 25C and 25K for supplying toner, respectively.

A transfer unit rotates the intermediate belt 28 in a clockwise direction when viewed from the front of FIG. 1 to transfer the monochromatic toner images from the photoconductive drums 22 to the intermediate belt 28. Thus, it transfers the monochromatic toner images in conjunction with the rotation of the photoconductive drums 22Y, 22M, 22C and 22K and the rotation of the primary transfer rollers 27Y, 27M, 27C and 27K at the opposite position. It can transfer the monochromatic toner images onto the intermediate belt 28 efficiently by supplying the primary transfer rollers 27Y, 27M, 27C and 27K with appropriate bias voltage, and by providing difference between the rotation speed of the photoconductive drums 22Y, 22M, 22C and 22K and the rotation speed of the intermediate belt 28. This is referred to as primary transfer.

In addition, the transfer unit superimposes the monochromatic toner images on the intermediate belt 28 at respective stations, and conveys the superimposed multicolor toner image to a secondary transfer roller 29 in conjunction with the rotation of the intermediate belt 28. Furthermore, it carries the recording medium 11 from a paper tray 21a or 21b to the secondary transfer roller 29, and transfers the multicolor toner image on the intermediate belt 28 to the recording medium 11. The toner image is transferred electrostatically while applying appropriate bias voltage to the secondary transfer roller 29. This is referred to as secondary transfer. As for the secondary transfer roller 29, it makes contact with the recording medium 11 at a position 29a while transferring the multicolor toner image onto the recording medium 11, and is separated to a position 29b after the printing processing.

A fixing unit includes a fixing roller 32 for heating the recording medium 11 and a pressure roller 33 for bringing the recording medium 11 into pressure contact with the fixing roller 32 in order to fusion fixing the multicolor toner image transferred to the recording medium 11 onto the recording medium 11. The fixing roller 32 and the pressure roller 33 are made hollow, and include heaters 34 and 35 in them. A fixing device 31 conveys the recording medium 11 storing the multicolor toner image with the fixing roller 32 and pressure roller 33, and fixes the toner to the recording medium 11 by applying heat and pressure.

The recording medium 11 after the toner fixing is ejected to a paper output tray not shown by an ejecting roller not shown, and thus the image forming operation is completed. A cleaning unit 30 is a device for cleaning toner remaining on the intermediate belt 28. The waste toner left after transferring the 4-color multicolor toner image formed on the intermediate belt 28 to the recording medium 11 is stored in a cleaner container.

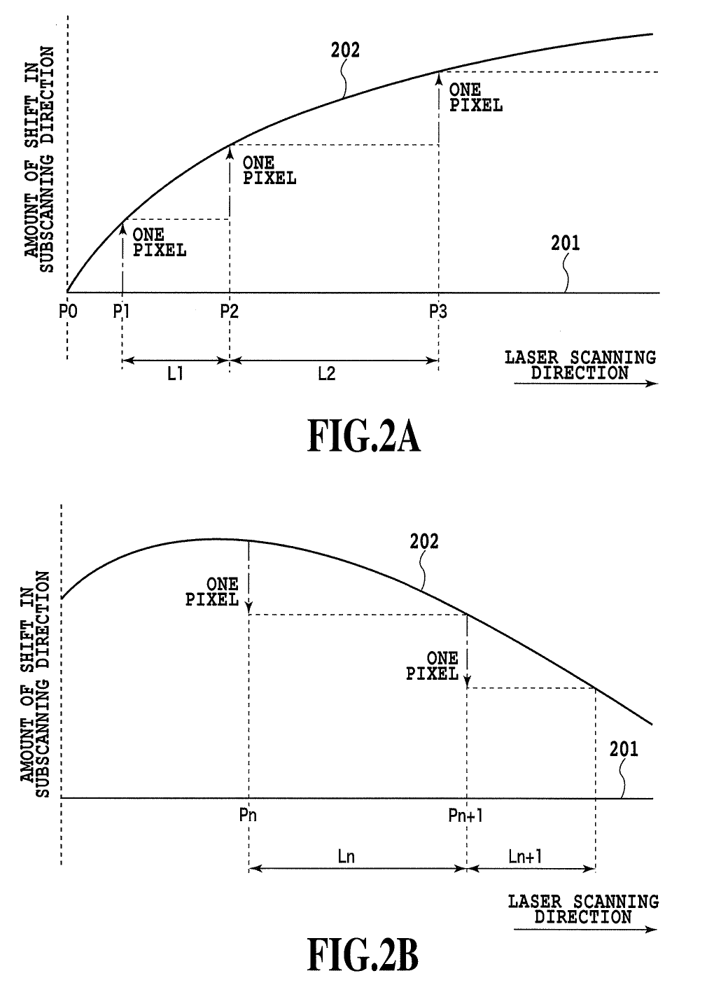

Next, referring to FIG. 2A and FIG. 2B, the profile characteristics of the scanning line of each color of the image forming device will be described. FIG. 2A is a diagram showing as the profile characteristics of the image forming device a region in which actual laser scanning shifts upward from the ideal subscanning direction. In addition, FIG. 2B is a diagram showing as the profile characteristics of the image forming device a region in which the actual laser scanning shifts downward from the ideal subscanning direction. The reference numeral 201 designates the ideal scanning line, and the characteristics are shown in the case where the scanning is performed in the direction perpendicular to the rotating direction of the photoconductive drums 22Y, 22M, 22C and 22K.

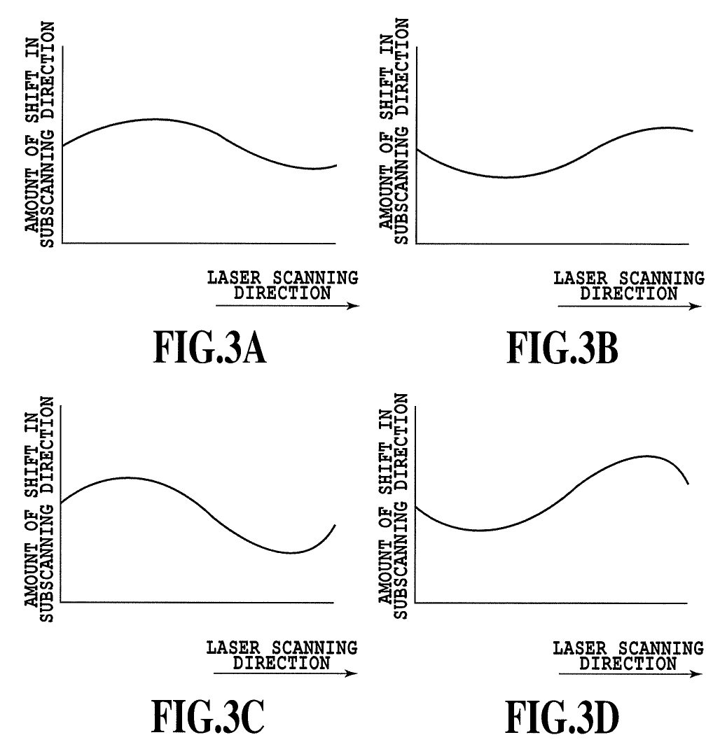

Incidentally, as for the profile characteristics in the following description, although they are defined with respect to the direction in which the image processing unit 402 makes correction (direction of making correction), the definition of the profile characteristics is not limited to that. Thus, such a configuration is also possible which defines the profile with respect to the shift direction of the laser scanning (the direction of the shift itself) in the image forming unit 401, and carries out opposite characteristic correction by the image processing unit 402. FIG. 3A to FIG. 3D show correlation between directions in which the image processing unit 402 makes corrections according to the profile definition and directions of shift of the laser scanning in the image forming unit 401. If the profile characteristics shown in FIG. 3A are given as those indicating the direction in which the image processing unit 402 makes corrections, the curve characteristics indicating the shift direction in the image forming unit 401 become as those shown in FIG. 3B indicating the direction opposite to the profile characteristics. On the contrary, if the profile characteristics shown FIG. 3C are given as the curve characteristics indicating the shift direction in the image forming unit 401, the profile characteristics as shown in FIG. 3D are given as those indicating the direction in which the image processing unit 402 makes corrections.

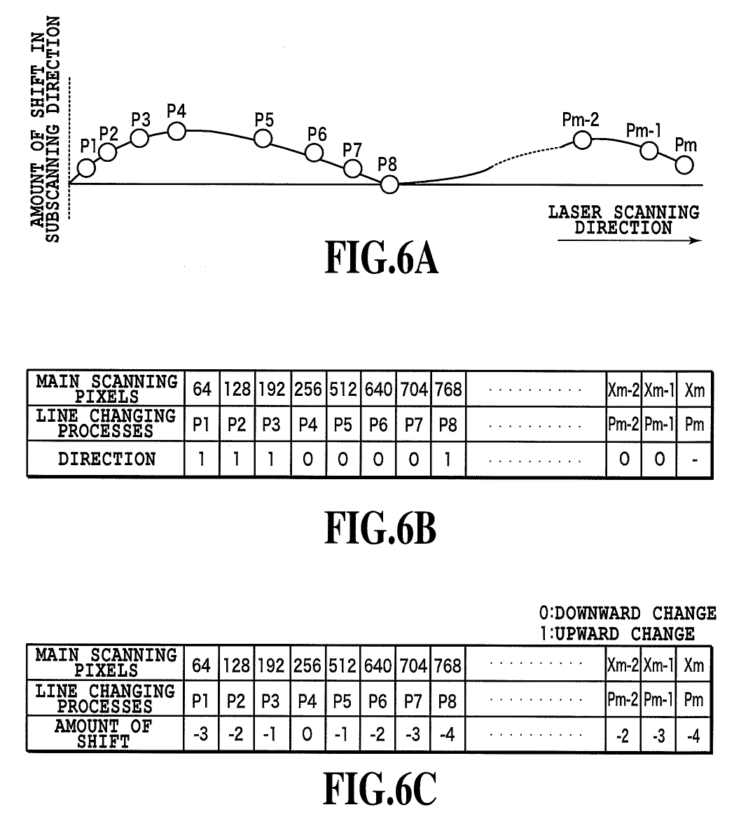

In addition, as shown in FIG. 6A to FIG. 6C, for example, as for a method of storing the profile characteristic data, it stores pixel positions in the main scanning direction at line changing processes and directions of changes up to the next line changing processes. More specifically, concerning the profile characteristics shown in FIG. 6A, the line changing processes P1, P2, P3, . . . , Pm are defined. The definition of each line changing process is made at a point at which one pixel shift occurs in the subscanning direction, and as for the direction, there are cases where the changes occur in the upward direction and downward direction as far as the next line changing process.

For example, the line changing process P2 becomes a point at which the upward transfer is to be made as far as the next line changing process P3. Thus, the transfer direction at P2 becomes an upward direction (↑). Likewise, the transfer direction at P3 becomes an upward direction (↑) to the next line changing process P4. The transfer direction at the line changing process P4 differs from the directions so far, and becomes a downward direction (↓). As a method of storing the direction data, assume that “1” is assigned as the data indicating the upward direction and “0” is assigned as the data indicating the downward direction, for example, then the data become as shown at the bottom of FIG. 6B. In this case, the number of data indicating the transfer directions becomes equal to the number of the line changing processes. Thus, if the number of the line changing processes is m, the number of bits to be stored as the information indicating the transfer directions is also m bits.

In addition, on the basis of the highest point among all the line changing processes (P4 in the example of FIG. 6A to FIG. 6C), a table (FIG. 6C) is created which stores the amounts of shift at the line changing processes.

The reference numeral 202 of FIG. 2 designates an actual scanning line with slopes and a curve resulting from the positioning accuracy and difference in diameter of the photoconductive drums 22Y, 22M, 22C and 22K and from the positioning accuracy of the optical system in the scanner units 24C, 24M, 24Y and 24K of the individual colors shown in FIG. 1. Generally, in the image forming device, the profile characteristics differ between individual recording devices (recording engines), and in addition, as for the color image forming device, the characteristics differ from color to color.

Here, referring to FIG. 2A, the line changing processes in a region that actually shifts upward with respect to the ideal laser scanning direction will be described.

The term “line changing process” in the present embodiment refers to a point that shifts by one pixel in the subscanning direction. For example, in FIG. 2A, the points P1, P2 and P3, which shift by one point in the subscanning direction on the upwardly curved characteristics 202, correspond to the line changing processes. Here, FIG. 2A shows a curve with reference to the point P0. As is seen from FIG. 2A, the distance between the line changing processes (L1, L2) becomes shorter in a region where the curved characteristics 202 change steeply, and becomes longer in a region where they change gently.

Next, referring to FIG. 2B, the line changing processes in a region, which actually shift downward with respect to the ideal laser scanning direction, will be described. In the region which shows the characteristics that shift downward as shown in FIG. 2B, the line changing process is also defined as a point that shifts by one pixel in the subscanning direction against the main scanning direction. For example, in FIG. 2B, the points Pn and Pn+1, which shift by one pixel in the subscanning direction on the downwardly curved characteristics 202, correspond to the line changing processes. In FIG. 2B, as in FIG. 2A, the distance between the line changing processes (Ln, Ln+1) also becomes shorter in a region where the curved characteristics 202 change steeply, and longer in a region where they change gently.

In this way, the line changing processes are closely related with the rate of change of the curved characteristics 202 of the image forming device. Thus, the image forming device with steeply curved characteristics has a large number of line changing processes, but the image forming device with gently curved characteristics has a small number of line changing processes.

As described already, since the curved characteristics of the image forming device differ from color to color, the number of the line changing processes and their positions differ, respectively. The difference between colors appears as the misregistration in the image obtained by transferring the toner images of all colors onto the intermediate belt 28. The present embodiment relates to the processing at the line changing processes, the details of which will be described with reference to other drawings.

Next, referring to FIG. 4, the processing of the image processing unit 402 in the color image forming device will be described.

An image generating unit 404 generates raster image data capable of being subjected to print processing according to print data (PDL data, for example) received from a computer system or the like not shown, and outputs pixel by pixel as RGB data and attribute data indicating data attributes of each pixel. Incidentally, the image generating unit 404 can be configured in such a manner as to include a reading unit within the color image forming device and to handle the image data from the reading unit rather than handling the image data indicated by the print data received from the computer system. The term called“reading unit” here includes at least a CCD (Charge-Coupled Device) or a CIS (Contact Image sensor). The image generating unit 404 can also be configured in such a manner as to further include a processing unit for executing prescribed image processing of the image data read out by the reading unit. It can also be configured in such a manner as to receive data from the reading unit via an interface not shown rather than including the reading unit within the color image forming device.

The reference numeral 405 designates a color converting unit that converts the RGB data to CMYK data in accordance with the toner colors of the image forming unit 402, and stores the CMYK data and attribute data to a storage unit 406 serving as a bitmap memory. The storage unit 406, which is a first storage unit of the image processing unit 402, temporarily stores the raster image data to be subjected to the print processing. Incidentally, the storage unit 406 can be configured as a page memory for storing image data of one page, or as a band memory for storing data of a plurality of lines.

Reference numerals 407C, 407M, 407Y and 407K designate a halftone processing unit each, which performs halftone processing on the attribute data and each color data output from the storage unit 406. As a concrete configuration of the halftone processing unit, there is one based on screen processing or on error diffusion processing. The screen processing performs N-level digitization using a plurality of prescribed dithering matrices and input image data. On the other hand, the error diffusion processing is the processing that performs N-level digitization by comparing the input image data with a prescribed threshold, and diffuses the difference between the input image data and the threshold at that time to neighboring pixels that will undergo the N-level digitization processing thereafter.

The reference numeral 408 designates a second storage unit (image data storage unit) which is placed within the image forming device, and stores the N-level digitization data processed by the halftone processing units 407 (407C, 407M, 407Y and 407K). Incidentally, when the pixel position to be subjected to the image processing in and after the storage unit 408 is a line changing process, one-pixel transfer is carried out at the time when it is read out from the storage unit 408.

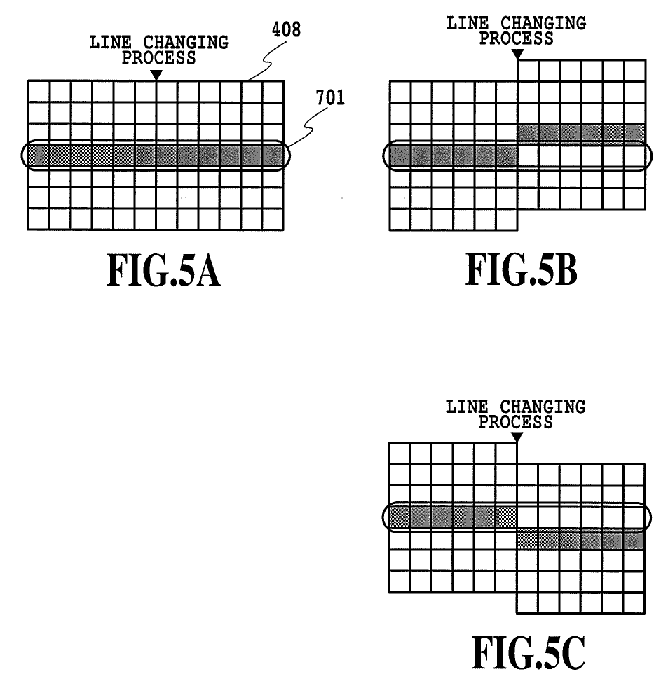

Here, the state of the data the storage unit 408 stores is shown in FIG. 5A. FIG. 5A is a schematic diagram showing the state of the data the storage unit 408 stores. As shown in FIG. 5A, in the condition in which it really stores at present, the storage unit 408 stores the data after the processing by the halftone processing unit 407 regardless of the correction direction the image processing unit 402 takes or the curved characteristics of the image forming unit 401. At the time when the line 701 of FIG. 5A is read out, if the direction to be corrected by the image processing unit 402 is upward, it is shifted by one pixel in the upward direction at a line changing process serving as a boundary as shown in FIG. 5B. In contrast, if the direction to be corrected by the image processing unit 402 is downward, the image data of the line 701 is shifted by one pixel in the downward direction at the line changing process serving as the boundary as shown in FIG. 5C at the time when it is read out of the storage unit 408.

Reference numerals 409C, 409M, 409Y and 409K designate an interpolation determination unit of each color, which makes a determination as to whether a pixel, which is N-level digitization data input and is placed before or after a line changing process, is a pixel that requires interpolation in post-stage processing or a pixel that does not require any interpolation.

Reference numerals 410C, 410M, 410Y and 410K designate a timing adjusting unit configured to establish synchronization between the N-level digitization data fed from the storage unit 408 and the determination result of the interpolation determination unit 409. Reference numerals 411C, 411M, 411Y and 411K designate a transfer buffer for temporarily storing the output data of the interpolation determination unit 409 and the output data of the timing adjusting unit 410. Although the present description is made that the first storage unit 406, second storage unit 408 and transfer buffer 411 are configured separately, they can be configured as a common storage unit within the image forming device.

Reference numerals 412C, 412M, 412Y and 412K each designate an interpolation processing unit that performs interpolation processing of the data received from the transfer buffer 411C, 411M, 411Y or 411K according to the determination result by the interpolation determination unit 409, which is transferred from the same transfer buffer. Although the determination result fed from the interpolation determination unit 409 is a determination as to each pixel, the interpolation processing in the interpolation processing unit 412 employs the pixels before and after each line changing process corresponding to the curved characteristics of the laser scanning of the image forming device. FIG. 5A to FIG. 5C show an interpolation method at the line changing process.

FIG. 6A to FIG. 6C described before show a distortion manner and its profile data (curve correction information) on laser scanning of a single color. The profile data about the individual colors become profile data 416C, 416M, 416Y and 416K, which are stored in the storage unit 403 in the image forming device. The profile data includes data about positions of the pixels in the main scanning direction, which indicate the line changing processes, and 1-bit data indicating which one of the upward and downward directions the correction is to be made at the positions. The profile data are measured in advance, and the measured results are stored in the storage unit (curve correction information storage unit) 403 as the profile data.

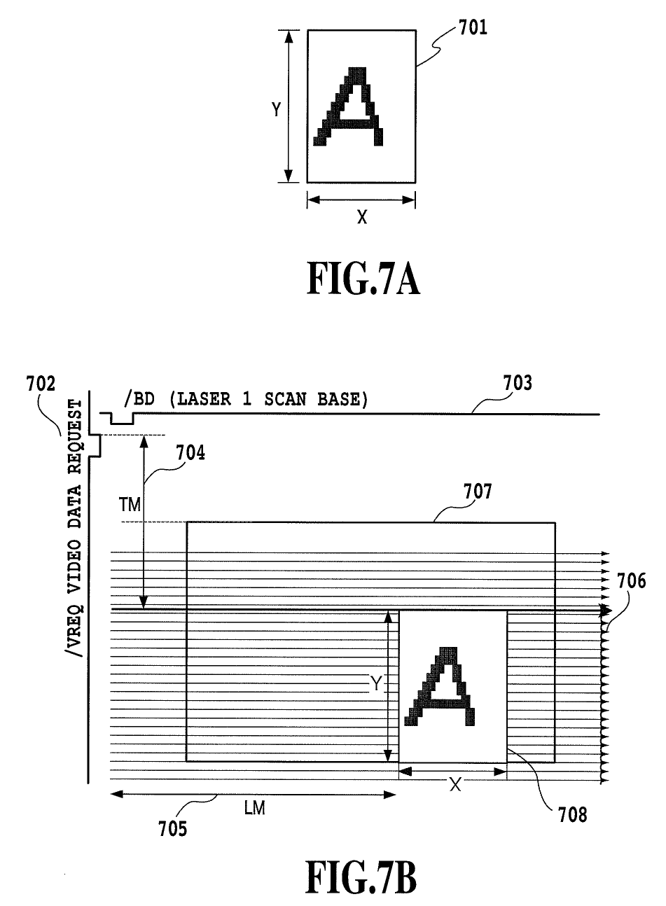

FIG. 7A shows the image data (701) generated on a main memory in the image forming device with the number of pixels in the horizontal direction being X and the number of pixels in the vertical direction being Y. When the image data (701) is formed as a visible image on paper through the image forming by the image forming device, it is generated as shown in FIG. 7B within the image forming device. In this case, the image forming is carried out on the basis of the vertical synchronizing signal /VREQ (video data request) and the horizontal synchronizing signal /BD (laser 1 scan base).

The reference numeral 707 shown in FIG. 7B designates image paper. The image forming is carried out by laying out (708) the image data 701 shown in FIG. 7A on the paper 707 under the assumption that the amount of shift in the vertical direction is TM (704) from the point of reference /VREQ, and that the amount of shift in the horizontal direction is LM (705) from the point of reference /BD. Here, the reference numeral 706 in FIG. 7B designates the movement of the laser for performing the image forming in the image forming device.

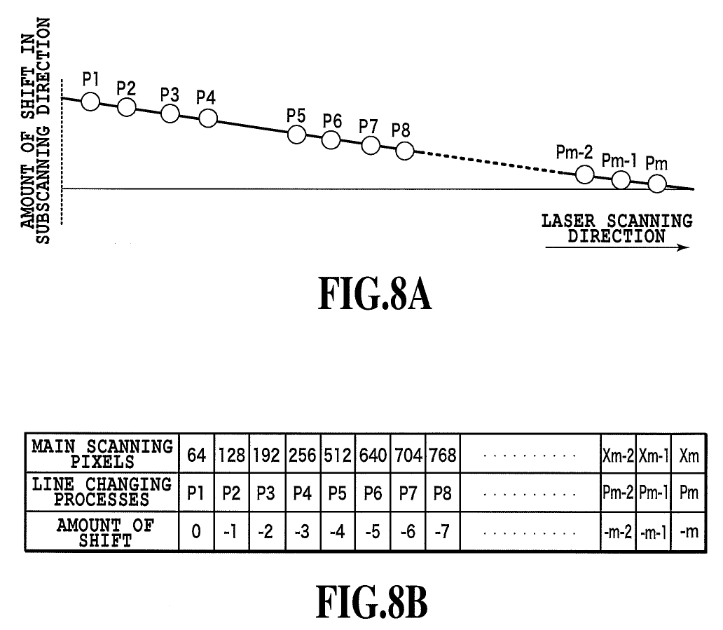

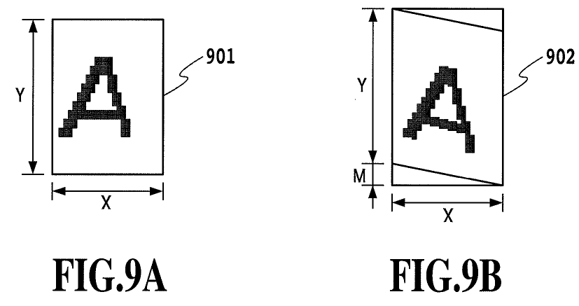

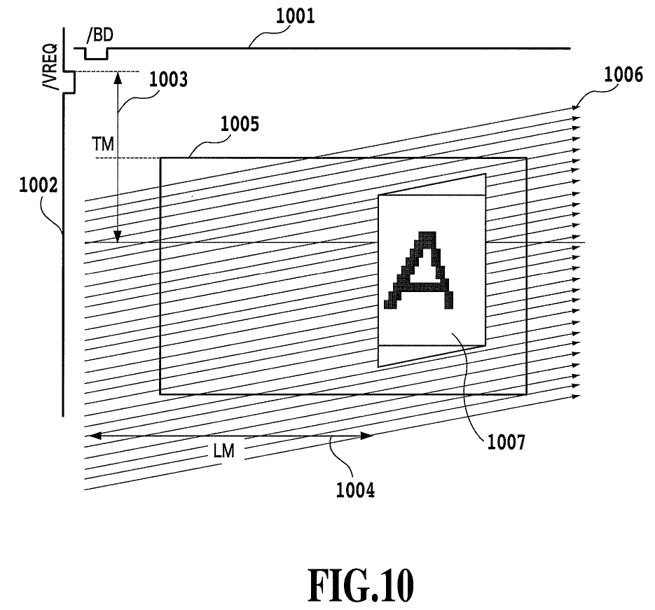

Next, consider a case where the profile data are as shown in FIG. 8A and FIG. 8B in the image forming device that has the unevenness or mounting position difference of lenses of the deflection scanning device and depends on the production accuracy. More specifically, consider the case of carrying out the image forming of the image data shown in FIG. 9A under the assumption that the amount of shift in the vertical direction is TM (1003 in FIG. 10) from the point of reference /VREQ and the amount of shift in the horizontal direction is LM (1004 in FIG. 10) from the point of reference /BD. In this case, the image forming is performed on the basis of the image data read out of the memory that stores the image data in the state as shown in FIG. 9B. In the example of FIG. 8A, FIG. 8B, FIG. 9A and FIG. 9B, assume that LM=512, X=256. Then, the value M in FIG. 9B (Δ{(the amount of shift at LM+X)−(the amount of shift at LM)}) becomes Δ((−7)−(−4))=3 from FIG. 8B. Here, Δ is an operator that calculates the absolute value.

In addition, considering that the amount of shift of the pixel at the position LM is −4 in the subscanning direction, the image start position will be shifted by four lines in the upward direction from the originally desired position.

Accordingly, in the foregoing embodiment, shifting the image data by four lines at the left end portion makes it possible to form the image data at the right position without any shift with respect to the paper.

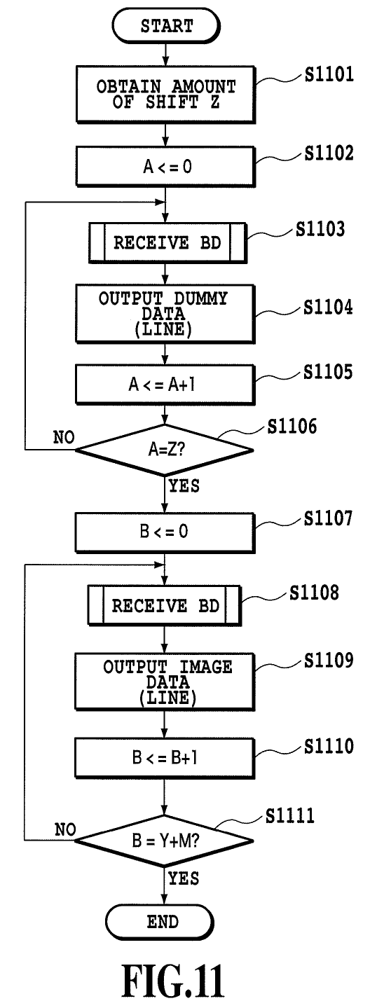

Next, a flow of the processing in the present embodiment will be described with reference to FIG. 4 and the flowchart of FIG. 11. Although the following description is made by way of example of a single color C (cyan), the same processing is executed for each of the other colors M, Y and K. Incidentally, in FIG. 11, “<=” designates an operator indicating to substitute the right side term for the left side term.

It is assumed in the present embodiment that the timing adjusting unit 410C within the image processing unit 402 in the color image forming device uses the profile data 416C that stores the distortion state at the time of scanning by the laser scanner corresponding to the timing adjusting unit 410C.

First, at step S1101, from the profile data shown in FIG. 8A and FIG. 8B, for example, the absolute value of the amount of shift of the image forming start position of each color in the subscanning direction in the image forming device is obtained when the correction is not made, and is substituted for “Z”. In the example of FIG. 8A and FIG. 8B, Z=4.

Next, at step S1102, the timing adjusting unit 410C resets a variable A (A=0), and waits for the horizontal synchronizing signal BD 1001, which is generated in the timing adjusting unit 410C, to become active (Low).

Next, receiving that the BD 1001 becomes active at step S1103, the timing adjusting unit 410C generates the dummy data of the image data (for X pixels) in the main scanning direction within the timing adjusting unit 410C. Then, it delivers the dummy data it generates to the transfer buffer 411C (step S1104). Here, the transfer buffer 411C stores the dummy data in order from the image forming start position before correction. The transfer buffer 411C transfers the dummy data it stores to the scanner unit (deflection scanning device) 414C in the image forming unit via the interpolation processing unit 412C and a PWM 413C for converting to the exposure time of the image data. Then, the scanner unit 414C carries out exposure to the photoconductive drum 415C.

Next, the timing adjusting unit 410C adds one to the variable A (step S1105). Then, according to the value of the variable A and the amount of shift Z, it makes a determination as to whether it transfers the dummy data (corresponding to white) by the number of lines required to the transfer buffer 411C (that is, A=Z) or not (step S1106). Thus, it repeats the steps S1103 to S1106 until it completes the transfer of the dummy data.

After completing the output of the dummy data, the timing adjusting unit 410C reads out the data to be printed from the storage unit 408 in the same procedure as that from step S1102 to step S1106, and delivers to the transfer buffer 411C. Thus, it executes the procedure from step S1108 to step S1111. The data delivered to the transfer buffer 411C is transferred to the scanner unit 414C in the image forming unit via the interpolation processing unit 412C and the PWM 413C so that the scanner unit 414C carries out the exposure to the photoconductive drum 415C.

From step S1107 to step S1111, however, using a variable B, the timing adjusting unit 410C reads out the image data line by line from the storage unit 408 until B=Y+M is satisfied, and delivers the image data to the transfer buffer 411C. Finally, it completes a series of processing by transferring the image data with the shape as shown in FIG. 9B to the image forming unit.

As for other timing adjusting units 410M, 410Y and 410K, they add the dummy data in the same processing procedure.

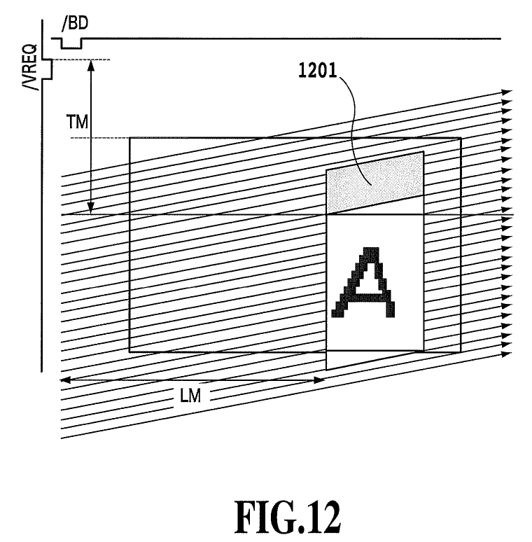

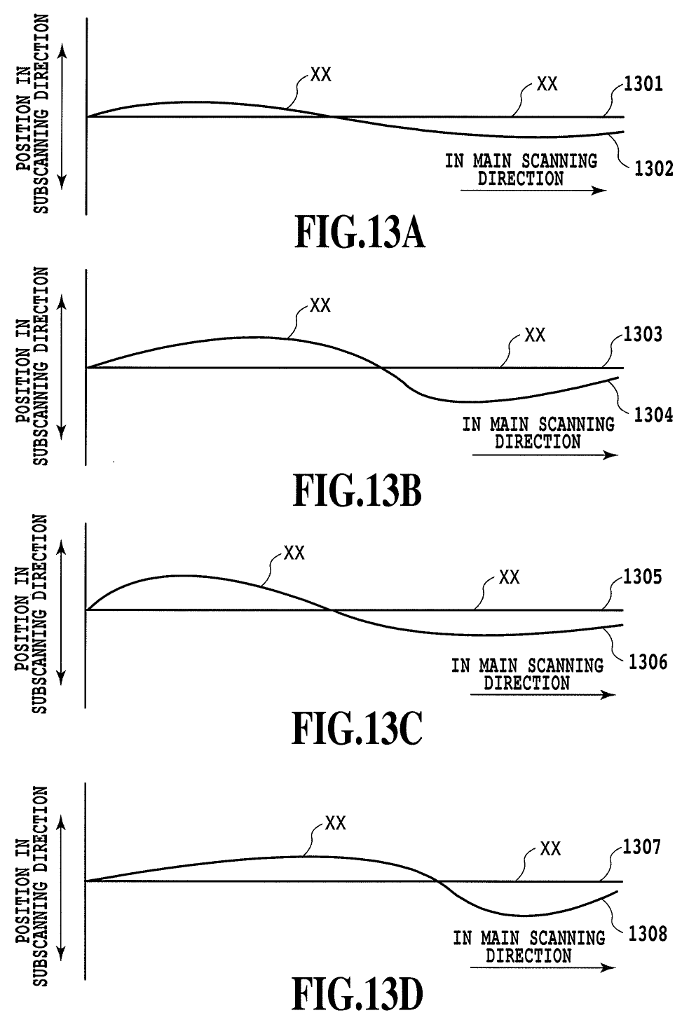

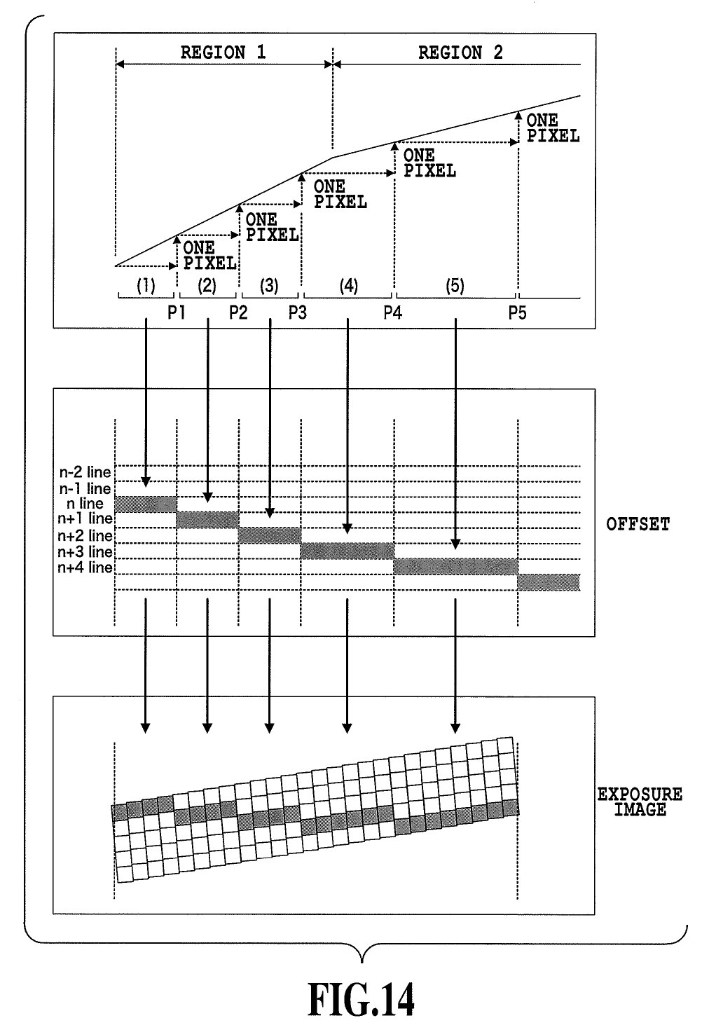

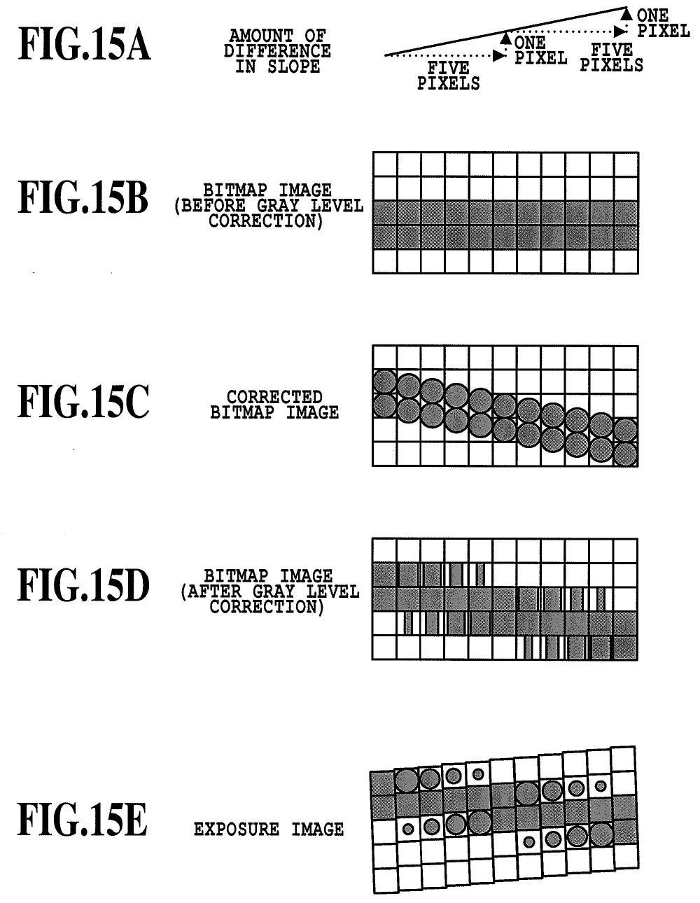

As described before, the image forming device has the unevenness of lenses of the deflection scanning device or the mounting position difference thereof. Such an image forming device results in forming, at the time of carrying out the image forming, the image at a position different from the predetermined position or the position designated by a user in the subscanning direction depending on the layout position of the image in the main scanning direction (FIG. 10). In contrast with this, according to the forgoing flow, the present embodiment can perform the image forming at a desired position (FIG. 12) without any complex calculation by the firmware on the image forming position at the time of the image forming as in the conventional device.

### Other Embodiments

The object of the present invention can be achieved by reading and executing, with a computer (or CPU or MPU) of the system or device, the program code for implementing the procedures of the flowchart shown in the embodiment described above from a storage medium that stores the program code. In this case, the program code itself read out of the storage medium implements the functions of the foregoing embodiments. Accordingly, the program code or a computer readable storage medium that stores or records the program code constitutes the present invention as well.

As the storage medium for supplying the program code, a floppy disk, hard disk, optical disk, magneto-optical disk, CD-ROM, CD-R, magnetic tape, nonvolatile memory card, ROM and the like can be used.

Besides, the functions of the foregoing embodiments are implemented not only by executing the program code the computer reads out. For example, such a case is also included where an OS (operating system) or the like working on the computer performs part or all of the actual processing according to the instructions of the program, and that processing implements the functions of the foregoing embodiment.

Furthermore, the functions of the foregoing embodiment can also be implemented by the processing in which a function expansion board inserted into a computer or a function expansion unit connected to the computer which executes part or all of the actual processing. In this case, the program code read out of the storage medium is written into a memory in the expansion board or in the expansion unit, and then executed by the CPU or the like according to the instructions of the program code.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-308996, filed Nov. 29, 2007, which is hereby incorporated by reference herein in its entirety.

What is claimed is:

1. An image forming device, comprising:
an image data storage component configured to store image data corresponding to at least one color component of an image;
a reading component configured to read out the image data on the basis of a designated reading position of the image data corresponding to each color component stored in the image data storage component;
an image forming component configured to form an image of each color component to paper according to the image data read out of the image data storage component by the reading component;
a curve correction information storage component configured to store curve correction information depending on accuracy of an exposure unit included in the image forming component; and
a correction component configured to correct the designated reading position of the image data of each color component in accordance with the curve correction information of each color component, the curve correction information of each color component being read out of the curve correction information storage component by the reading component in conjunction with the image data, wherein
the correction component obtains the amount of shift in a subscanning direction of image forming from the image forming position of the image data in the main scanning direction and from the curve correction information, adds dummy data by the number of lines of shifting the designated reading position of the image data at the image forming start position in accordance with the amount of shift obtained, and transmits the dummy data added and the image data to the image forming component.

2. The image forming device of claim 1, wherein the image forming device consists of a tandem color image forming device.

3. An image forming method in an image forming device including:
an image data storage component configured to store image data corresponding to at least one color component of an image;
a reading component configured to read out the image data on the basis of a designated reading position of the image data corresponding to each color component stored in the image data storage component;
an image forming component configured to form an image of each color component to paper according to the image data read out of the image data storage component by the reading component;
a curve correction information storage component configured to store curve correction information depending on accuracy of an exposure unit of the image forming component; and
a correction component configured to correct the designated reading position of the image data of each color component in accordance with the curve correction information of each color component, the curve correction information of each color component being read out of the curve correction information storage component by the reading component in conjunction with the image data,
wherein the image forming method comprising the steps of:
obtaining the amount of shift in a subscanning direction of image forming from the image forming position of the image data in the main scanning direction and from the curve correction information;
adding dummy data by the number of lines of shifting the designated reading position of the image data at the image forming start position in accordance with the amount of shift obtained; and
transmitting the dummy data added and the image data to the image forming component.

4. The image forming method of claim 3, wherein the image forming device consists of a tandem color image forming device.

5. A computer-readable recording medium having computer-executable instructions for performing an image forming method in an image forming device including:
an image data storage component configured to store image data corresponding to at least one color component of an image;
a reading component configured to read out the image data on the basis of a designated a reading position of the image data corresponding to each color component stored in the image data storage component;
an image forming component configured to form an image of each color component to paper according to the image data read out of the image data storage component by the reading component;
a curve correction information storage component configured to store curve correction information depending on accuracy of an exposure unit of the image forming component; and
a correction component configured to correct the designated reading position of the image data of each color component in accordance with the curve correction information of each color component, the curve correction information of each color component being read out of the curve correction information storage component by the reading component in conjunction with the image data,
wherein the image forming method comprises the steps of:
obtaining the amount of shift in a subscanning direction of image forming from the image forming position of the image data in the main scanning direction and from the curve correction information;
adding dummy data by the number of lines of shifting the designated reading position of the image data at the image forming start position in accordance with the amount of shift obtained; and
transmitting the dummy data added and the image data to the image forming component.

6. A computer-readable recording medium having computer-executable instructions for performing the method of claim 5, wherein the image forming device consists of a tandem color image forming device.
